(19) United States
(12) Patent Application Publication
(10) Pub. No.: US 2025/0079090 A1
(43) Pub. Date: Mar. 6, 2025

(54) SOLID ELECTROLYTIC CAPACITOR AND CAPACITOR ARRAY

(71) Applicant: Murata Manufacturing Co., Ltd., Nagaokakyo-shi (JP)

(72) Inventors: Daiki HABU, Nagaokakyo-shi (JP); Takeshi FURUKAWA, Nagaokakyo-shi (JP)

(21) Appl. No.: 18/952,325

(22) Filed: Nov. 19, 2024

Related U.S. Application Data
(63) Continuation of application No. PCT/JP2023/018684, filed on May 19, 2023.

(30) Foreign Application Priority Data
May 27, 2022 (JP) 2022-087190

(51) Int. Cl. H01G 9/048; H01G 9/028; H01G 9/07; H01G 9/15

(52) U.S. Cl. CPC H01G 9/048; H01G 9/028; H01G 9/07; H01G 9/15

(57) ABSTRACT

A solid electrolytic capacitor that includes: an anode plate including a core portion, a porous layer having pores on at least one main surface of the core portion, and a dielectric layer on a surface of the porous layer and extending into the pores of the porous layer; and a cathode layer that includes a solid electrolyte layer on a surface of the dielectric layer. The solid electrolyte layer includes a conductive polymer layer inside the pores of the porous layer, the conductive polymer layer comprising a mixture of a conductive polymer and an insulating material. The insulating material is a material which contains an OH group, a COOH group, a CO group, or an NH₂ group in a molecule, has hygroscopicity, and does not have a function as a dopant for the above-described conductive polymer.

### CROSS REFERENCE TO RELATED APPLICATIONS

The present application is a continuation of International application No. PCT/JP2023/018684, filed May 19, 2023, which claims priority to Japanese Patent Application No. 2022-087190, filed May 27, 2022, the entire contents of each of which are incorporated herein by reference.

### TECHNICAL FIELD

The present disclosure relates to a solid electrolytic capacitor and a capacitor array.

### BACKGROUND ART

The solid electrolytic capacitor includes, for example, an anode plate provided with a dielectric layer on a surface of a porous layer provided on at least one main surface of a core portion, and made of a valve action metal such as aluminum; and a cathode layer including a solid electrolyte layer provided on the surface of the dielectric layer.

Patent Document 1 discloses a solid electrolytic capacitor in which a moisture absorbing agent is disposed in the vicinity of a solid electrolyte provided on a dielectric. Patent Document 1 describes silica gel, calcium oxide, anhydrous calcium chloride, anhydrous sodium sulfate, and anhydrous copper sulfate as examples of the moisture absorbing agent.
Patent Document 1: Japanese Unexamined Patent Application Publication No. 3-276620

### SUMMARY OF THE DISCLOSURE

According to Patent Document 1, it is said that the deterioration of characteristics in a high-temperature high-humidity environment is small because the moisture absorbing agent disposed in the vicinity of the solid electrolyte effectively adsorbs the intruding moisture that has passed through the exterior.

However, in a case of considering completely blocking the moisture intrusion path to the solid electrolytic capacitor, it is difficult to dispose the layer of moisture absorbing agent (hereinafter referred to as a moisture absorbing layer) around the entire periphery of the solid electrolytic capacitor by a method of disposing the moisture absorbing layer on the outer side portion of the solid electrolytic capacitor as shown in the drawing of Patent Document 1. In particular, in a case where one capacitor sheet is cut and divided into individual solid electrolytic capacitors in order to manufacture a capacitor array in which the plurality of solid electrolytic capacitors are present inside the sealing layer, it is difficult to dispose the moisture absorbing layer around the entire periphery of each solid electrolytic capacitor.

An object of the present disclosure is to provide a solid electrolytic capacitor capable of suppressing a fluctuation in capacitance associated with moisture absorption. Further, an object of the present disclosure is to provide a capacitor array in which two or more of the above-described solid electrolytic capacitors are present inside the sealing layer.

A solid electrolytic capacitor according to the present disclosure includes: an anode plate including a core portion, a porous layer having pores on at least one main surface of the core portion, and a dielectric layer on a surface of the porous layer and extending into the pores of the porous layer; and a cathode layer that includes a solid electrolyte layer on a surface of the dielectric layer, the solid electrolyte layer including a conductive polymer layer inside the pores of the porous layer, the conductive polymer layer comprising a mixture of a conductive polymer and an insulating material, wherein the insulating material is a material which contains an OH group, a COOH group, a CO group, or an NH₂ group in a molecule, has hygroscopicity, and does not have a function as a dopant for the above-described conductive polymer.

A capacitor array according to the present disclosure includes: the solid electrolytic capacitor according to the present disclosure; a sealing layer covering the solid electrolytic capacitor; a first outer electrode and a second outer electrode on an outer side portion of the sealing layer; a via conductor inside the sealing layer; and a through-hole conductor penetrating the sealing layer in the thickness direction of the solid electrolytic capacitor. Two or more of the solid electrolytic capacitors are present inside the above-described sealing layer. The through-hole conductor is electrically connected to an end surface of the anode plate of the solid electrolytic capacitor on a side wall thereof. The first outer electrode is electrically connected to the anode plate of the solid electrolytic capacitor with the through-hole conductor interposed therebetween. The second outer electrode is electrically connected to the cathode layer of the solid electrolytic capacitor with the via conductor interposed therebetween.

According to the present disclosure, it is possible to provide a solid electrolytic capacitor capable of suppressing a fluctuation in capacitance associated with moisture absorption. Furthermore, according to the present disclosure, it is possible to provide a capacitor array in which two or more of the solid electrolytic capacitors are present inside the sealing layer.

### BRIEF DESCRIPTION OF THE DRAWINGS

FIG. 1 is a cross-sectional view schematically showing an example of a capacitor array according to the present disclosure.

FIG. 2 is an enlarged cross-sectional view of a part of the capacitor array shown in FIG. 1, which is surrounded by a broken line.

FIG. 3 is a perspective view schematically showing an internal structure of the capacitor array shown in FIG. 1.

FIG. 4 is a perspective view schematically showing an example of a step of preparing an anode plate.

FIG. 5 is an enlarged cross-sectional view of a part of the anode plate shown in FIG. 4, which is surrounded by a broken line.

FIG. 6 is a cross-sectional view schematically showing an example of a step of forming a first conductive polymer layer.

FIG. 7 is a cross-sectional view schematically showing an example of a step of forming a second conductive polymer layer.

FIG. 8 is a perspective view schematically showing an example of a step of forming a third conductive polymer layer.

FIG. 9 is an enlarged cross-sectional view of a part of the anode plate shown in FIG. 8, which is surrounded by a broken line.

FIG. 10 is a perspective view schematically showing an example of a step of forming a first conductor layer.

FIG. 11 is a perspective view schematically showing an example of a step of forming a second conductor layer.

FIG. 12 is a perspective view schematically showing an example of a step of dividing the anode plate on which a cathode layer is formed.

FIG. 13 is a perspective view schematically showing an example of a step of forming a second through-hole.

FIG. 14 is a perspective view schematically showing an example of a step of forming a sealing layer.

FIG. 15 is a perspective view schematically showing an example of a step of forming a first through-hole.

FIG. 16 is a perspective view schematically showing an example of a step of forming a through-hole conductor.

FIG. 17 is a perspective view schematically showing an example of a step of forming a via conductor.

FIG. 18 is a cross-sectional view schematically showing another example of the capacitor array according to the present disclosure.

FIG. 19 is an enlarged cross-sectional view of a part of the capacitor array shown in FIG. 18, which is surrounded by a broken line.

FIG. 20 is a cross-sectional view schematically showing an example of a capacitor array of Comparative Example 1.

FIG. 21 is an enlarged cross-sectional view of a part of the capacitor array shown in FIG. 20, which is surrounded by a broken line.

FIG. 22 is a graph showing a relationship between a humidity and a capacitance variation rate in the solid electrolytic capacitor of Example 2 and Comparative Example 1.

### DESCRIPTION OF THE PREFERRED EMBODIMENTS

Hereinafter, the solid electrolytic capacitor and the capacitor array according to the present disclosure will be described.

However, the present disclosure is not limited to the following configurations, and can be applied after being appropriately modified without changing the gist of the present disclosure. Note that a combination of two or more of separate desired configurations of the present disclosure, which will be described below, is also the present disclosure.

In the following examples, the capacitor array according to the present disclosure will be described with reference to the accompanying drawings. The solid electrolytic capacitor contained in such a capacitor array is also one aspect of the present disclosure. Two or more solid electrolytic capacitors according to the present disclosure are present inside the sealing layer, or only one solid electrolytic capacitor may be present.

The drawings shown below are schematic diagrams, and the dimensions, aspect ratio scale, and the like may differ from an actual product.

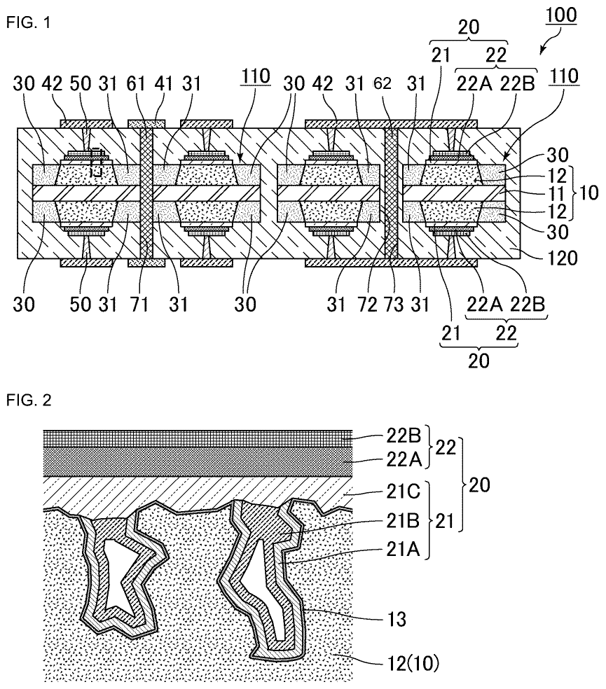

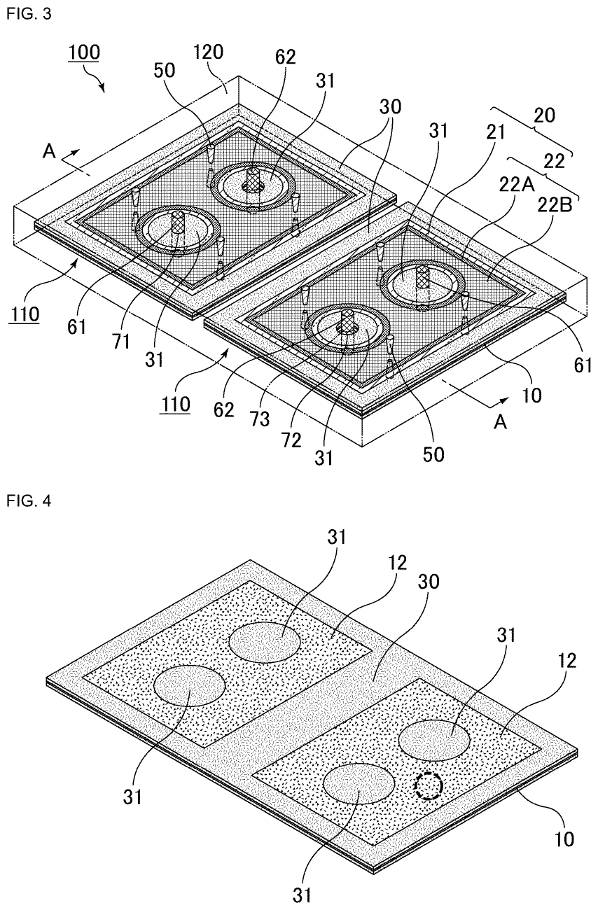

FIG. 1 is a cross-sectional view schematically showing an example of a capacitor array according to the present disclosure. FIG. 2 is an enlarged cross-sectional view of a part of the capacitor array shown in FIG. 1, which is surrounded by a broken line. FIG. 3 is a perspective view schematically showing an internal structure of the capacitor array shown in FIG. 1. In FIG. 3, a first outer electrode and a second outer electrode are omitted. FIG. 1 is a cross-sectional view taken along line A-A of the capacitor array shown in FIG. 3.

A capacitor array 100 shown in FIG. 1 includes a plurality of solid electrolytic capacitors 110 and a sealing layer 120 provided to cover the solid electrolytic capacitors.

The solid electrolytic capacitor 110 includes an anode plate 10 and a cathode layer 20.

The anode plate 10 includes a core portion 11, a porous layer 12 provided on at least one main surface of the core portion 11, and a dielectric layer 13 provided on a surface of the porous layer 12 (refer to FIG. 2). In FIG. 1, the porous layer 12 of the anode plate 10 is shown alone, but in reality, as shown in FIG. 2, a part of the solid electrolyte layer 21 constituting the cathode layer 20 is provided inside the pores (recessed portions) of the porous layer 12 along with the dielectric layer 13. The same applies to the following cross-sectional views.

The anode plate 10 is made of a valve action metal that exhibits a so-called valve action. Examples of the valve action metal include a metal element such as aluminum, tantalum, niobium, titanium, and zirconium, and an alloy containing at least one of these metals. Among these, aluminum or an aluminum alloy is preferable.

The shape of the anode plate 10 is preferably a flat plate shape and more preferably a foil shape. In the anode plate 10, the porous layer 12 may be provided on at least one main surface of the core portion 11, and the porous layer 12 may be provided on each main surface of the core portion 11. The porous layer 12 is preferably an etching layer formed on the surface of the anode plate 10.

The thickness of the anode plate 10 before the etching treatment is preferably 60 μm to 200 μm. The thickness of the core portion 11 not etched after the etching treatment is preferably 15 μm to 70 μm. The thickness of the porous layer 12 is designed according to the required withstand voltage and electrostatic capacity, but it is preferable that the total thickness of the porous layers 12 on both sides of the core portion 11 is 10 μm to 180 μm.

A hole diameter of the pores of the porous layer 12 is preferably 10 nm to 600 nm. The hole diameter of the pores of the porous layer 12 means a median diameter D50 measured by a mercury porosimeter. The hole diameter of the pores of the porous layer 12 can be controlled, for example, by adjusting various conditions in etching.

The dielectric layer 13 reflects the surface state of the porous layer 12, and has a finely uneven surface shape (refer to FIG. 2) corresponding to the pores of the porous layer 12. It is preferable that the dielectric layer 13 is made of the oxide film of the valve action metal. For example, in a case where an aluminum foil is used as the anode plate 10, the dielectric layer 13 made of an oxide film can be formed by performing an anodization treatment (also referred to as chemical conversion treatment) on the surface of the aluminum foil in an aqueous solution containing ammonium adipate or the like.

A thickness of the dielectric layer 13 is designed according to the required withstand voltage and electrostatic capacity, but is preferably 10 nm to 100 nm.

The cathode layer 20 is provided on the surface of the dielectric layer 13. In a case where the first insulating layer 30, which will be described later, is provided on the anode plate 10, it is preferable that the cathode layer 20 is provided on the surface of the dielectric layer 13 in a region surrounded by the first insulating layer 30 (hereinafter also referred to as an element region). The cathode layer 20 may be provided to extend to the surface of the first insulating layer 30.

The cathode layer 20 includes a solid electrolyte layer 21 provided on the surface of the dielectric layer 13. It is preferable that the cathode layer 20 further includes a conductor layer 22 provided on the surface of the solid electrolyte layer 21. In FIG. 1, the solid electrolyte layer 21 is shown in a state of being completely isolated from the porous layer 12 of the anode plate 10, but in reality, as shown in FIG. 2, a part of the solid electrolyte layer 21 is provided inside the pores (recessed portions) of the porous layer 12 along with the dielectric layer 13.

The solid electrolyte layer 21 contains a conductive polymer.

Examples of a configuration material of the solid electrolyte layer 21 include conductive polymers such as polypyrroles, polythiophenes, and polyanilines. Among these, polythiophenes are preferable, and poly(3,4-ethylenedioxythiophene) (PEDOT) is particularly preferable. In addition, the conductive polymer may contain a dopant such as polystyrene sulfonic acid (PSS).

The thickness of the solid electrolyte layer 21 from the surface of the anode plate 10 is preferably 2 μm to 20 μm.

The thickness of the solid electrolyte layer 21 can be measured by an electron micrograph of a cross-section of the anode plate 10 in the thickness direction as shown in FIG. 2. The method of measuring the thickness of each layer constituting the solid electrolyte layer 21, which will be described later, is the same.

The solid electrolyte layer 21 includes a conductive polymer layer in which a conductive polymer and an insulating material are mixed inside the pores of the porous layer 12. The above-described insulating material is a material which contains an OH group, a COOH group, a CO group, or an NH₂ group in a molecule, has hygroscopicity, and does not have a function as a dopant for the above-described conductive polymer.

In the solid electrolytic capacitor 110, the solid electrolyte layer 21 includes an insulating material having hygroscopicity at a part provided inside the pores of the porous layer 12. Therefore, the fluctuation in the capacitance accompanying the moisture absorption of the conductive polymer can be suppressed by the expansion of the insulating material.

For example, in a case of manufacturing the solid electrolytic capacitor 110 by cutting one capacitor sheet, particularly, in a case where one capacitor sheet is cut and divided into the individual solid electrolytic capacitors 110 in order to manufacture the capacitor array 100 in which the plurality of solid electrolytic capacitors 110 are present inside the sealing layer 120, unlike Patent Document 1, it is not necessary to dispose the moisture absorbing layer around the entire periphery of the solid electrolytic capacitor 110 after the cutting, and thus it is possible to easily suppress the fluctuation in the capacitance due to the moisture absorption.

In addition, in a case where a via conductor 50, a through-hole conductor 61, or a through-hole conductor 62, which will be described later, is provided in the capacitor array 100, in the method where the moisture absorbing layer is disposed around the entire periphery of the solid electrolytic capacitor 110, the through-hole for forming the via conductor 50 or the like should be formed in the moisture absorbing layer, and thus it becomes difficult to obtain a sufficient moisture-proof effect. From this point as well, it is preferable that the insulating material having hygroscopicity is contained in the solid electrolyte layer 21. The same applies to a case where one solid electrolytic capacitor 110 is present inside the sealing layer 120, in addition to a case where a plurality of the solid electrolytic capacitors 110 are present inside the sealing layer 120.

As described above, the effect of the insulating material having hygroscopicity contained in the solid electrolyte layer 21 is an effect of the capacitor array 100, and can also be said to be an effect of the solid electrolytic capacitor 110.

Examples of the insulating material contained in the conductive polymer layer include a phenol-based material. The insulating material contained in the conductive polymer layer may have a function of supplying hydrogen radicals (H•) to stabilize radicals (R•) generated by heat within a molecular chain of the conductive polymer and peroxy radicals (ROO•) generated by reaction of the above-described radicals (R•) with oxygen.

In the example shown in FIG. 2, the solid electrolyte layer 21 includes a first conductive polymer layer 21A, a second conductive polymer layer 21B, and a third conductive polymer layer 21C. In this example, the first conductive polymer layer 21A and the second conductive polymer layer 21B are provided inside the pores of the porous layer 12, and the second conductive polymer layer 21B contains an insulating material. However, only the conductive polymer layer containing an insulating material may be provided inside the pores of the porous layer 12.

The insulating material contained in the conductive polymer layer preferably does not have a function as a dopant for the conductive polymer contained in the solid electrolyte layer 21. For example, in a case where the solid electrolyte layer 21 includes the first conductive polymer layer 21A containing the first conductive polymer, the second conductive polymer layer 21B containing the second conductive polymer, and the third conductive polymer layer 21C containing the third conductive polymer, it is preferable that the insulating material does not have a function as a dopant for the first conductive polymer, the second conductive polymer, or the third conductive polymer.

The first conductive polymer layer 21A is provided inside the pores (recessed portions) of the porous layer 12. The first conductive polymer layer 21A may cover the entire pores of the porous layer 12, or may cover a part of the pores of the porous layer 12.

The first conductive polymer layer 21A is a layer containing the first conductive polymer. The first conductive polymer may be used alone or in combination of two or more types thereof. The number of the first conductive polymer layers 21A may be one or two or more.

The first conductive polymer is, for example, a conductive polymer represented by poly(3,4-ethylenedioxythiophene), and is a material soluble in a solvent.

The first conductive polymer may contain a dopant as necessary.

The first conductive polymer layer 21A is formed, for example, by a method of coating the surface of the anode plate 10 with a liquid containing the first conductive polymer, preferably a liquid in which the first conductive polymer is dissolved, and drying the liquid. Specifically, the first conductive polymer layer 21A can be formed in a predetermined region by applying the above-described liquid to the surface of the anode plate 10 by a method such as an immersion method (dipping method), sponge transfer, screen printing, dispenser coating, or ink jet printing.

The second conductive polymer layer 21B is provided inside the pores (recessed portions) of the porous layer 12 and covers the first conductive polymer layer 21A. The second conductive polymer layer 21B may cover the entire first conductive polymer layer 21A, or may cover a part of the first conductive polymer layer 21A. The second conductive polymer layer 21B may fill the pores (recessed portions) of the porous layer 12.

The second conductive polymer layer 21B is a layer in which the second conductive polymer and the insulating material are mixed. The second conductive polymer may be used alone or in combination of two or more types thereof. Similarly, the insulating material may be alone or two or more types. The number of the second conductive polymer layers 21B may be one or two or more.

The second conductive polymer is preferably a conductive polymer different from the first conductive polymer. The second conductive polymer is, for example, a conductive polymer represented by poly(3,4-ethylenedioxythiophene), and is a material having a larger particle size than the first conductive polymer and being insoluble in a solvent, but having high heat resistance.

The second conductive polymer may contain a dopant as necessary.

It is preferable that the insulating material is not present unevenly inside the second conductive polymer layer 21B, and it is more preferable that the insulating material is uniformly dispersed inside the second conductive polymer layer 21B.

The thickness of the second conductive polymer layer 21B may be the same as the thickness of the first conductive polymer layer 21A, may be larger than the thickness of the first conductive polymer layer 21A, or may be smaller than the thickness of the first conductive polymer layer 21A.

The second conductive polymer layer 21B is formed, for example, by a method of simultaneously coating the surface of the anode plate 10, on which the first conductive polymer layer 21A is formed, with a liquid containing the second conductive polymer, preferably a liquid in which the second conductive polymer is dispersed, and a liquid containing an insulating material, preferably a liquid in which the insulating material is dissolved, and drying the liquid. Specifically, the second conductive polymer layer 21B can be formed in a predetermined region by simultaneously applying the above-described liquids to the surface of the anode plate 10 on which the first conductive polymer layer 21A is formed, by a method such as an immersion method (dipping method), sponge transfer, screen printing, dispenser coating, or ink jet printing.

The third conductive polymer layer 21C is provided on the surface of the anode plate 10 and covers at least the second conductive polymer layer 21B. The third conductive polymer layer 21C may cover not only the second conductive polymer layer 21B but also the first conductive polymer layer 21A.

The third conductive polymer layer 21C is a layer containing the third conductive polymer. The third conductive polymer layer 21C preferably further contains a binder. The number of the third conductive polymer layers 21C may be one or two or more.

The third conductive polymer may be the same conductive polymer as the first conductive polymer, or may be the same conductive polymer as the second conductive polymer. The third conductive polymer may be used alone or in combination of two or more types thereof. The third conductive polymer may contain a dopant as necessary.

The thickness of the third conductive polymer layer 21C is preferably larger than the thickness of the first conductive polymer layer 21A, and preferably larger than the thickness of the second conductive polymer layer 21B.

The third conductive polymer layer 21C is formed, for example, by a method of coating the surface of the anode plate 10, on which the first conductive polymer layer 21A and the second conductive polymer layer 21B are formed, with a liquid containing the third conductive polymer, and drying the liquid. Specifically, the third conductive polymer layer 21C can be formed in a predetermined region by applying the above-described liquid to the surface of the anode plate 10 on which the first conductive polymer layer 21A the second conductive polymer layer 21B are formed, by a method such as an immersion method (dipping method), sponge transfer, screen printing, dispenser coating, or ink jet printing.

Alternatively, the third conductive polymer layer 21C may be formed by forming a polymerized film of the third conductive polymer on the surface of the anode plate 10 on which the first conductive polymer layer 21A and the second conductive polymer layer 21B are formed, by using a liquid containing a monomer such as 3,4-ethylenedioxythiophene. In this case as well, the third conductive polymer layer 21C can be formed in a predetermined region by applying the above-described liquid onto the surface of the anode plate 10 on which the first conductive polymer layer 21A and the second conductive polymer layer 21B have been formed, by a method such as an immersion method (dipping method), sponge transfer, screen printing, dispenser coating, or ink jet printing.

In order to suppress the risk of short-circuiting due to direct contact between the core portion 11 of the anode plate 10 and the conductor layer 22, it is preferable that the third conductive polymer layer 21C is formed such that the core portion 11 of the anode plate 10 is not exposed on the surface by using a liquid having a higher viscosity than the liquid used for forming the first conductive polymer layer 21A and the second conductive polymer layer 21B.

The conductor layer 22 includes at least one of the conductive resin layer and the metal layer. The conductor layer 22 may be formed of only the conductive resin layer or only the metal layer. The conductor layer 22 may cover the entire solid electrolyte layer 21, or may cover a part of the solid electrolyte layer 21.

Examples of the conductive resin layer include a conductive adhesive layer containing at least one conductive filler selected from the group consisting of a silver filler, a copper filler, a nickel filler, and a carbon filler.

Examples of the metal layer include a metal plating film and a metal foil. The metal layer is preferably made of at least one metal selected from the group consisting of nickel, copper, silver, and an alloy containing these metals as a main component. The “main component” refers to an element component having the highest weight proportion.

The conductor layer 22 includes, for example, a first conductor layer 22A provided on the surface of the solid electrolyte layer 21 and a second conductor layer 22B provided on the surface of the first conductor layer 22A. As described above, the conductor layer 22 preferably includes a plurality of types of conductor layers.

The first conductor layer 22A is, for example, a conductive resin layer containing a conductive filler. The conductive filler is preferably at least one selected from the group consisting of a silver filler, a copper filler, a nickel filler, and a carbon filler.

The second conductor layer 22B is, for example, a conductive resin layer containing a metal filler. The metal filler is preferably at least one selected from the group consisting of a copper filler, a silver filler, and a nickel filler.

For example, the conductor layer 22 includes a carbon layer as the first conductor layer 22A and a copper layer as the second conductor layer 22B.

The carbon layer is provided to electrically and mechanically connect the solid electrolyte layer 21 and the copper layer. The carbon layer can be formed in a predetermined region by applying a carbon paste onto the solid electrolyte layer 21 by an immersion method (dipping method), sponge transfer, screen printing, dispenser coating, ink jet printing, or the like. It is preferable that the copper layer of the next step is laminated on the carbon layer in a viscous state before drying. The thickness of the carbon layer is preferably 2 μm to 20 μm.

The copper layer can be formed by applying a copper paste onto the carbon layer by an immersion method (dipping method), sponge transfer, screen printing, spray coating, dispenser coating, ink jet printing, or the like. The thickness of the copper layer is preferably 2 μm to 20 μm.

As shown in FIGS. 1 and 3, it is preferable that the first insulating layer 30 is provided on the surface of the porous layer 12 in a region where the cathode layer 20 is not located. The first insulating layer 30 is provided to surround the cathode layer 20 in the thickness direction. The first insulating layer 30 partitions an element region of the solid electrolytic capacitor 110.

Among the plurality of solid electrolytic capacitors 110, all the solid electrolytic capacitors 110 may be surrounded by the first insulating layer 30, or the solid electrolytic capacitors 110 that are not surrounded by the first insulating layer 30 may be present. Among the solid electrolytic capacitors 110 surrounded by the first insulating layer 30, the entire periphery of the solid electrolytic capacitor 110 may be surrounded by the first insulating layer 30, or a part of the periphery of the solid electrolytic capacitor 110 may be surrounded by the first insulating layer 30.

Further, the first insulating layer 31 may be provided on the surface of the porous layer 12 in a region where the cathode layer 20 is not located. The first insulating layer 31 is provided on the inner side portion of the cathode layer 20 in the thickness direction. In other words, the first insulating layer 31 is provided in the element region of the solid electrolytic capacitor 110. It is preferable that the first insulating layer 31 is provided to be separated from the first insulating layer 30.

Among the plurality of element regions, at least one first insulating layer 31 may be provided in at least one element region. In the example shown in FIG. 3, two first insulating layers 31 are provided in each of the element regions.

Both the first insulating layers 30 and 31 may be provided on the surface of the porous layer 12, or only one of them may be provided.

The first insulating layers 30 and 31 may be provided on the surface of the dielectric layer 13 on the porous layer 12. It is preferable that the first insulating layers 30 and 31 are provided to fill the pores (recessed portions) of the porous layer 12 or the dielectric layer 13.

The first insulating layers 30 and 31 contain an insulating material.

The first insulating layers 30 and 31 preferably are made of a resin. Examples of the resin constituting the first insulating layers 30 and 31 include insulating resins such as a polyphenylsulfone resin, a polyethersulfone resin, a cyanate ester resin, a fluororesin (tetrafluoroethylene, a tetrafluoroethylene-perfluoroalkyl vinyl ether copolymer, and the like), a polyimide resin, a polyamideimide resin, and an epoxy resin, and derivatives or precursors thereof. The first insulating layers 30 and 31 may be formed of the same resin or different resins.

Since there is a concern that the inorganic filler contained in the first insulating layers 30 and 31 may have an adverse effect on the effective portion of the solid electrolytic capacitor 110, it is preferable that the first insulating layers 30 and 31 are made of a resin alone.

The first insulating layers 30 and 31 can be formed, for example, by coating the porous layer 12 with a mask material such as a composition containing an insulating resin by a method such as sponge transfer, screen printing, dispenser coating, or ink jet printing.

The thickness of the first insulating layers 30 and 31 from the surface of the anode plate 10 is preferably 20 μm or less. The thickness of the first insulating layers 30 and 31 from the surface of the anode plate 10 may be 0 μm, but is preferably 2 μm or more. The thicknesses of the first insulating layers 30 and 31 may be the same as or different from each other.

The thicknesses of the first insulating layers 30 and 31 can be measured by an electron micrograph of a cross-section of the anode plate 10 in the thickness direction.

A planar shape of the first insulating layer 31 when viewed in the thickness direction is not particularly limited, and examples thereof include a polygonal shape such as a quadrangular shape, a circular shape, and an elliptical shape. In a case where two or more first insulating layers 31 are provided in the element region, the sizes, the planar shapes, and the like of the first insulating layers 31 when viewed in the thickness direction may be the same as each other, or some or all of them may be different from each other.

A position where the first insulating layer 31 is provided in the element region is not particularly limited. In a case where two or more first insulating layers 31 are provided in the element region, the positions where the first insulating layers 31 are provided may be the same as each other, or some or all of them may be different from each other.

Although not shown, a part of the first conductive polymer layer 21A and/or a part of the second conductive polymer layer 21B may be exposed on the surface of the anode plate 10. In that case, it is preferable that the area of the region where the first conductive polymer layer 21A and the second conductive polymer layer 21B are not present on the surface of the anode plate 10 is larger than the area of the region where the first conductive polymer layer 21A and the second conductive polymer layer 21B are present on the surface of the anode plate 10. In addition, on the surface of the anode plate 10, of the first conductive polymer layer 21A and the second conductive polymer layer 21B, only a part of the first conductive polymer layer 21A may be exposed, only a part of the second conductive polymer layer 21B may be exposed, or both a part of the first conductive polymer layer 21A and a part of the second conductive polymer layer 21B may be exposed.

The first conductive polymer layer 21A and/or the second conductive polymer layer 21B, which are exposed on the surface of the anode plate 10, are preferably in contact with the first insulating layer 30. In particular, it is preferable that a part of the first conductive polymer layer 21A and/or a part of the second conductive polymer layer 21B is exposed along the inner edge of the first insulating layer 30. In that case, a part of the first conductive polymer layer 21A and/or a part of the second conductive polymer layer 21B may be exposed along the entirety of the inner edge of the first insulating layer 30, or may be exposed along a part of the inner edge of the first insulating layer 30.

A part of the third conductive polymer layer 21C may enter the inside of the pores of the porous layer 12. In a case where the third conductive polymer layer 21C covers the pores of the porous layer 12 and enters the inside of the pores of the porous layer 12, the anchor effect of the third conductive polymer layer 21C makes it easier to suppress the occurrence of delamination between the porous layer 12 and the solid electrolyte layer 21.

A depth into which the third conductive polymer layer 21C enters is not particularly limited, and when a cross-section of the anode plate 10 in the thickness direction as shown in FIG. 2 is observed, a part of the third conductive polymer layer 21C may enter the inside of the pores of the porous layer 12.

In a case where a part of the third conductive polymer layer 21C enters the inside of the pores of the porous layer 12, the cathode layer 20 may include the conductor layer 22 and the conductor layer 22 may include a conductive resin layer containing a metal filler. For example, in a case where the second conductor layer 22B is a conductive resin layer containing a metal filler, a difference in thermal characteristics such as a coefficient of linear expansion between the solid electrolyte layer 21 and the conductor layer 22 is large, and thus delamination between the solid electrolyte layer 21 and the conductor layer 22 is likely to occur. Even in such a case, a part of the third conductive polymer layer 21C enters the inside of the pores of the porous layer 12, and thus delamination between the solid electrolyte layer 21 and the conductor layer 22 can be suppressed.

It is preferable that the sealing layer 120 is provided to cover the entire outer peripheral portion of the solid electrolytic capacitor 110, that is, to cover the upper, lower, left, and right sides of the solid electrolytic capacitor 110.

The sealing layer 120 contains an insulating material.

The sealing layer 120 is preferably formed of a resin. Examples of the resin constituting the sealing layer 120 include an epoxy resin and a phenol resin. The sealing layer 120 may be formed of the same resin as the first insulating layer 30 or 31.

The sealing layer 120 further preferably contains a filler. Examples of the filler contained in the sealing layer 120 include inorganic fillers such as silica particles, alumina particles, and metal particles.

The sealing layer 120 may be composed of only one layer, or may be composed of two or more layers. In a case where the sealing layer 120 is composed of two or more layers, the materials constituting each layer may be the same as or different from each other.

A layer such as a stress relaxation layer or a moisture-proof film may be provided between the sealing layer 120 and the cathode layer 20, between the sealing layer 120 and the first insulating layer 30, or between the sealing layer 120 and the first insulating layer 31.

The stress relaxation layer is preferably composed of an insulating resin. Examples of the insulating resin constituting the stress relaxation layer include an epoxy resin, a phenol resin, and a silicone resin. Furthermore, the stress relaxation layer preferably contains a filler. Examples of the filler contained in the stress relaxation layer include inorganic fillers such as silica particles, alumina particles, and metal particles. The insulating resin constituting the stress relaxation layer is preferably different from the resin constituting the sealing layer 120.

Since the sealing layer 120 is required to have characteristics such as adhesiveness with the outer electrode as the exterior member, it is difficult to simply match the coefficient of linear expansion of the sealing layer 120 with that of the solid electrolytic capacitor 110 or to select a resin having any elastic modulus. On the other hand, by providing the stress relaxation layer, it is possible to adjust the thermal stress design without losing each of the functions of the solid electrolytic capacitor 110 and the sealing layer 120.

It is preferable that the stress relaxation layer has lower moisture permeability than the sealing layer 120. In this case, in addition to the adjustment of the stress, the intrusion of the moisture into the solid electrolytic capacitor 110 can be reduced. The moisture permeability of the stress relaxation layer can be adjusted by the type of the insulating resin constituting the stress relaxation layer, the amount of the filler contained in the stress relaxation layer, and the like.

As shown in FIG. 1, the capacitor array 100 may further include a first outer electrode 41 and a second outer electrode 42 provided on the outer side portion of the sealing layer 120. In the example shown in FIG. 1, the first outer electrode 41 and the second outer electrode 42 are provided on both main surface sides of the sealing layer 120, but may be provided on only one main surface side.

The first outer electrode 41 is electrically connected to the anode plate 10 of the solid electrolytic capacitor 110. The second outer electrode 42 is electrically connected to the cathode layer 20 of the solid electrolytic capacitor 110. The first outer electrode 41 and the second outer electrode 42 can function as connection terminals of the solid electrolytic capacitor 110.

Examples of a material constituting the first outer electrode 41 and the second outer electrode 42 include a low-resistance metal such as silver, gold, and copper. A configuration material of the first outer electrode 41 may be the same as or different from a material constituting the second outer electrode 42. The first outer electrode 41 and the second outer electrode 42 are formed by, for example, a plating treatment or the like.

In order to improve the adhesiveness between the first outer electrode 41 and other members or between the second outer electrode 42 and other members, a mixed material of at least one type of conductive filler selected from the group consisting of a silver filler, a copper filler, a nickel filler, and a carbon filler, and a resin may be used as a material constituting the first outer electrode 41 and the second outer electrode 42.

As shown in FIGS. 1 and 3, the capacitor array 100 may further include the via conductor 50 provided inside the sealing layer 120. In the example shown in FIG. 1, the via conductor 50 is provided on both main surface sides of the sealing layer 120, but may be provided on only one main surface side.

The via conductor 50 is provided to reach the cathode layer 20 (in the example shown in FIG. 1, the second conductor layer 22B) from the surface of the sealing layer 120 in the thickness direction. As a result, the second outer electrode 42 is electrically connected to the cathode layer 20 of the solid electrolytic capacitor 110 with the via conductor 50 interposed therebetween.

Examples of a material constituting the via conductor 50 include a low-resistance metal such as silver, gold, and copper.

The via conductor 50 is formed, for example, as follows. First, the sealing layer 120 is subjected to drilling, laser processing, or the like to form a hole reaching the cathode layer 20 (for example, the second conductor layer 22B) from the surface of the sealing layer 120 in the thickness direction. Then, the via conductor 50 is formed by performing a plating treatment on the inner wall surface of the hole formed in the sealing layer 120 or by filling the hole with a conductive paste and then performing a heat treatment.

As shown in FIGS. 1 and 3, the capacitor array 100 may further include the through-hole conductors 61 and 62 provided to penetrate the sealing layer 120 in the thickness direction. The through-hole conductors 61 and 62 are provided to penetrate the first insulating layer 31 in the thickness direction. In the example shown in FIGS. 1 and 3, both the through-hole conductors 61 and 62 are provided, but only one of them may be provided.

The through-hole conductor 61 is provided inside a first through-hole 71 that extends through the first insulating layer 31 in the thickness direction. In the example shown in FIGS. 1 and 3, the through-hole conductor 61 is provided to penetrate the solid electrolytic capacitor 110 and the sealing layer 120 in the thickness direction. The first outer electrode 41 is electrically connected to the anode plate 10 of the solid electrolytic capacitor 110 with the through-hole conductor 61 interposed therebetween. As shown in FIG. 1, it is preferable that the through-hole conductor 61 is electrically connected to the end surface of the anode plate 10 of the solid electrolytic capacitor 110 by the inner wall of the first through-hole 71 (that is, the side wall of the through-hole conductor 61). In the example shown in FIGS. 1 and 3, the through-hole conductor 61 is provided to fill the first through-hole 71, but the through-hole conductor 61 may be provided only on at least the inner wall surface of the first through-hole 71. In a case where the through-hole conductor 61 is provided on the inner wall surface of the first through-hole 71, it is preferable that the first through-hole 71 is filled with a resin material. In this case, the resin material that fills the first through-hole 71 can either be conductive or non-conductive.

The through-hole conductor 62 is provided inside a second through-hole 72 that extends through the first insulating layer 31 in the thickness direction. It is preferable that the hole diameter of the second through-hole 72 is larger than the hole diameter of the first through-hole 71. In the example shown in FIGS. 1 and 3, the through-hole conductor 62 is provided to penetrate the solid electrolytic capacitor 110 and the sealing layer 120 in the thickness direction. The through-hole conductor 62 is electrically connected to the cathode layer 20 of the solid electrolytic capacitor 110 with the second outer electrode 42 and the via conductor 50 interposed therebetween. As shown in FIG. 1, it is preferable that the through-hole conductor 62 is electrically insulated from the anode plate 10 of the solid electrolytic capacitor 110 by the inner wall of the second through-hole 72 (that is, the side wall of the through-hole conductor 62). In the example shown in FIGS. 1 and 3, the through-hole conductor 62 is provided to fill a third through-hole 73 having a hole diameter smaller than the hole diameter of the second through-hole 72, but the through-hole conductor 62 may be provided only on at least the inner wall surface of the third through-hole 73. The hole diameter of the third through-hole 73 may be the same as the hole diameter of the first through-hole 71, may be larger than the hole diameter of the first through-hole 71, or may be smaller than the hole diameter of the first through-hole 71. In a case where the through-hole conductor 62 is provided on the inner wall surface of the third through-hole 73, it is preferable that the third through-hole 73 is filled with a resin material. In this case, the resin material that fills the third through-hole 73 can either be conductive or non-conductive.

A cross-sectional shape of the first through-hole 71, the second through-hole 72, and the third through-hole 73 when viewed in the thickness direction is not particularly limited, and examples thereof include a polygonal shape such as a quadrangular shape, a circular shape, and an elliptical shape. The hole diameter refers to a diameter in a case where the cross-sectional shape is circular and a maximum length passing through the center of the cross-section in a case where the cross-sectional shape is not circular. The through-holes may have a taper in which the hole diameter decreases in the thickness direction.

The through-hole conductors 61 and 62 may be formed only on at least the inner wall surface of the through-hole. The inner wall surface of the through-hole is metallized with a low-resistance metal such as copper, gold, or silver. Due to ease of processing, metallization can be performed by, for example, electroless copper plating or electrolytic copper plating. The metallization of the through-hole conductors 61 and 62 is not limited to a case where only the inner wall surface of the through-hole is metallized, and the through-hole may be filled with a metal or a composite material of a metal and a resin.

Although not shown in FIGS. 1 and 3, the capacitor array 100 may further include a through-hole conductor other than the through-hole conductors 61 and 62. For example, the capacitor array 100 may further include a through-hole conductor that is not electrically connected to any of the anode plate 10 and the cathode layer 20 of the solid electrolytic capacitor 110.

In the capacitor array 100, two or more solid electrolytic capacitors 110 may be present inside the sealing layer 120. The plurality of solid electrolytic capacitors 110 may be disposed in a straight line or may be disposed in a planar shape when viewed in the thickness direction. In addition, the plurality of solid electrolytic capacitors 110 may be disposed regularly or may be disposed irregularly when viewed in the thickness direction. The sizes, the planar shapes, and the like of the solid electrolytic capacitor 110 when viewed in the thickness direction may be the same as each other, or some or all of them may be different from each other. Two or more types of solid electrolytic capacitors 110 having different areas when viewed in the thickness direction may be included.

The capacitor array 100 may include a solid electrolytic capacitor 110 of which the planar shape viewed in the thickness direction is not rectangular. In the present specification, “rectangle” means a square or an oblong rectangle. Therefore, for example, the solid electrolytic capacitor 110 having a planar shape of a polygonal shape such as a quadrangle, a triangle, a pentagon, and a hexagon other than the rectangle, a shape including a curved portion, a circular shape, an elliptical shape, and the like may be included in the capacitor array 100. In this case, two or more types of solid electrolytic capacitors 110 having different planar shapes may be included in the capacitor array 100. In addition to the solid electrolytic capacitor 110 having a non-rectangular planar shape, the capacitor array 100 can either include or exclude the solid electrolytic capacitor 110 having a rectangular planar shape.

As shown in FIGS. 1 and 3, it is preferable that the anode plate 10 is divided by the slit between at least one pair of solid electrolytic capacitors 110 adjacent to each other among the plurality of solid electrolytic capacitors 110. That is, it is preferable that the slit between the at least one pair of solid electrolytic capacitors 110 adjacent to each other extends through the anode plate 10 in the thickness direction. Between the solid electrolytic capacitors 110 adjacent to each other, the anode plates 10 may be physically divided. Therefore, the anode plates 10 may be electrically divided or electrically connected to each other between the solid electrolytic capacitors 110 adjacent to each other.

The width of the slit between the solid electrolytic capacitors 110 adjacent to each other is not particularly limited, but is preferably 15 μm or more, more preferably 30 μm or more, and still more preferably 50 μm or more. On the other hand, the width of the slit between the solid electrolytic capacitors 110 adjacent to each other is preferably 500 μm or less, more preferably 200 μm or less, and still more preferably 150 μm or less.

The slit between the solid electrolytic capacitors 110 adjacent to each other may have a taper in which the width is reduced in the thickness direction. In that case, the taper of the slit between the solid electrolytic capacitors 110 adjacent to each other can reach the anode plate 10 or does not necessarily need to reach the anode plate 10.

It is preferable that the space between the solid electrolytic capacitors 110 adjacent to each other is filled with the same material as the sealing layer 120. For example, as shown in FIG. 1, the space between the solid electrolytic capacitors 110 adjacent to each other is filled with the sealing layer 120.

Alternatively, the space between the solid electrolytic capacitors 110 adjacent to each other may be filled with the same material as the stress relaxation layer. For example, in a case where the capacitor array 100 includes the stress relaxation layer, the space between the solid electrolytic capacitors 110 adjacent to each other may be filled with the stress relaxation layer.

Hereinafter, as an example of the manufacturing method of the capacitor array according to the present disclosure, an example of a method of manufacturing the capacitor array 100 shown in FIG. 1 will be described step by step with reference to the drawings.

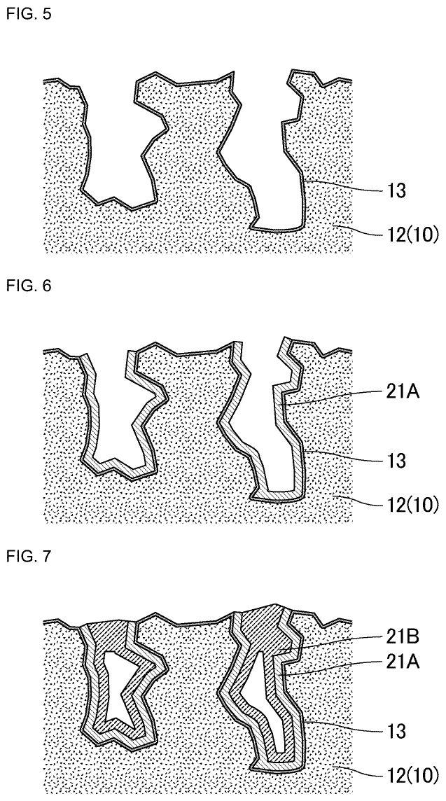

FIG. 4 is a perspective view schematically showing an example of a step of preparing an anode plate. FIG. 5 is an enlarged cross-sectional view of a part of the anode plate shown in FIG. 4, which is surrounded by a broken line.

For example, the anode plate 10 made of a valve action metal is prepared. The anode plate 10 includes the core portion 11 (refer to FIG. 1), the porous layer 12 (refer to FIGS. 1 and 5) provided on at least one main surface of the core portion 11, and the dielectric layer 13 (refer to FIG. 5) provided on a surface of the porous layer 12.

For example, by performing an anodization treatment on the anode plate 10 in which the porous layer 12 is provided on at least one main surface of the core portion 11, the dielectric layer 13 can be formed on the surface of the porous layer 12.

Alternatively, a chemically treated foil may be prepared as the anode plate 10 in which the dielectric layer 13 is provided on the surface of the porous layer 12.

As shown in FIG. 4, in order to partition the anode plate 10 into a plurality of element regions, the first insulating layer 30 is formed on the surface of the porous layer 12. The first insulating layer 30 may be formed on the surface of the dielectric layer 13 on the porous layer 12. It is preferable that the first insulating layer 30 is formed to fill the pores (recessed portions) of the porous layer 12 or the dielectric layer 13.

Further, the first insulating layer 31 may be formed on the surface of the porous layer 12 in the at least one element region. In that case, it is preferable that the first insulating layer 31 is formed to be separated from the first insulating layer 30. The first insulating layer 31 may be formed on the surface of the dielectric layer 13 on the porous layer 12. It is preferable that the first insulating layer 31 is formed to fill the pores (recessed portions) of the porous layer 12 or the dielectric layer 13.

Next, the cathode layer 20 is formed on the surface of the dielectric layer 13 in the element region partitioned by the first insulating layer 30. The cathode layer 20 may be formed to extend to the surface of the first insulating layer 30.

The step of forming the cathode layer 20 includes a step of forming the solid electrolyte layer 21 containing a conductive polymer on the surface of the dielectric layer 13.

The step of forming the solid electrolyte layer 21 includes, for example, a step of forming the first conductive polymer layer 21A, a step of forming the second conductive polymer layer 21B, and a step of forming the third conductive polymer layer 21C.

FIG. 6 is a cross-sectional view schematically showing an example of a step of forming a first conductive polymer layer.

As shown in FIG. 6, the first conductive polymer layer 21A is formed inside the pores (recessed portions) of the dielectric layer 13. The first conductive polymer layer 21A may be formed to cover the entire pores of the porous layer 12, or the first conductive polymer layer 21A may be formed to cover a part of the pores of the porous layer 12.

In the step of forming the first conductive polymer layer 21A, a layer containing the first conductive polymer is formed of a liquid containing the first conductive polymer. The first conductive polymer layer 21A is preferably formed of a liquid obtained by dissolving the first conductive polymer.

The first conductive polymer layer 21A is preferably formed by performing coating with a liquid containing the first conductive polymer. Specifically, the first conductive polymer layer 21A is formed, for example, by a method of coating the surface of the anode plate 10 with a liquid containing the first conductive polymer, preferably a liquid in which the first conductive polymer is dissolved, and drying the liquid. The coating and drying may be repeated any number of times depending on the required characteristics, but from the viewpoint of resistance to delamination, cost minimization, and the like, the coating and drying are preferably performed one time to three times.

FIG. 7 is a cross-sectional view schematically showing an example of a step of forming a second conductive polymer layer.

As shown in FIG. 7, the second conductive polymer layer 21B covering the first conductive polymer layer 21A is formed inside the pores (recessed portions) of the dielectric layer 13. The second conductive polymer layer 21B may be formed to cover the entire first conductive polymer layer 21A, or the second conductive polymer layer 21B may be formed to cover a part of the first conductive polymer layer 21A. The second conductive polymer layer 21B may be formed to fill the pores (recessed portions) of the dielectric layer 13.

In the step of forming the second conductive polymer layer 21B, a layer in which the second conductive polymer and the insulating material are mixed is formed of a liquid containing a second conductive polymer and a liquid containing an insulating material that contains an OH group, a COOH group, a CO group, or an NH: group in its molecule, has hygroscopicity, and does not have a function as a dopant for the conductive polymer. It is preferable that the second conductive polymer layer 21B is formed of a liquid obtained by dispersing the second conductive polymer having a larger particle size than the first conductive polymer and a liquid in which the insulating material is dissolved.

The particle size of the conductive polymer can be measured by a dynamic light scattering method (DLS).

It is preferable that the second conductive polymer layer 21B is formed by simultaneously performing coating with a liquid containing the second conductive polymer and a liquid containing an insulating material. Specifically, the second conductive polymer layer 21B is formed, for example, by a method of simultaneously coating the surface of the anode plate 10, on which the first conductive polymer layer 21A is formed, with a liquid containing the second conductive polymer, preferably a liquid in which the second conductive polymer is dispersed, and a liquid containing an insulating material, preferably a liquid in which the insulating material is dissolved, and drying the liquid. The coating and drying may be repeated any number of times depending on the required characteristics, but for example, in a case of forming a cathode layer containing a metal or in a case of forming a sealing layer, from the viewpoint of improving resistance to delamination, the coating and drying are preferably performed one time to five times.

The simultaneous coating with the liquid containing the second conductive polymer and the liquid containing the insulating material means that coating with one liquid is performed before the other liquid is dried, and the method thereof is not particularly limited.

In a method of simultaneously performing coating with a liquid containing the second conductive polymer and a liquid containing an insulating material, for example, in a combination of materials in which the dispersion stability of the second conductive polymer deteriorates due to the influence of the insulating material, it is possible to proceed with drying and fixing before the materials aggregate, as compared with a method of mixing the materials in advance.

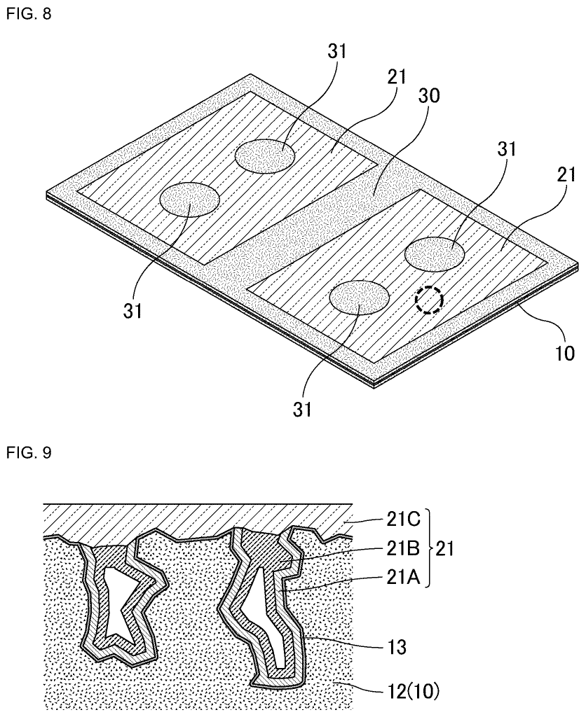

FIG. 8 is a perspective view schematically showing an example of a step of forming the third conductive polymer layer. FIG. 9 is an enlarged cross-sectional view of a part of the anode plate shown in FIG. 8, which is surrounded by a broken line.

As shown in FIGS. 8 and 9, the third conductive polymer layer 21C that covers at least the second conductive polymer layer 21B is formed on the surface of the anode plate 10. The third conductive polymer layer 21C may be formed to cover not only the second conductive polymer layer 21B but also the first conductive polymer layer 21A. By forming the third conductive polymer layer 21C, the solid electrolyte layer 21 is formed. In the example shown in FIG. 8, the solid electrolyte layer 21 is formed on the surface of the dielectric layer 13 in the element region partitioned by the first insulating layer 30.

In the step of forming the third conductive polymer layer 21C, a layer containing the third conductive polymer is formed of a liquid containing the third conductive polymer. It is preferable to use a liquid containing a binder in addition to the third conductive polymer.

The third conductive polymer layer 21C is formed, for example, by a method of coating the surface of the anode plate 10, on which the first conductive polymer layer 21A and the second conductive polymer layer 21B are formed, with a liquid containing the third conductive polymer, and drying the liquid. Alternatively, the third conductive polymer layer 21C may be formed, for example, by forming a polymerized film of the third conductive polymer on the surface of the anode plate 10 on which the first conductive polymer layer 21A and the second conductive polymer layer 21B are formed, by using a liquid containing a monomer such as 3,4-ethylenedioxythiophene.

In a sheet-like capacitor array in which there are many interfaces between different materials and a dimension in the thickness direction is smaller than a dimension in a plane direction, delamination due to stress is likely to occur. Therefore, in order to enhance the anchor effect in the pore part, it is preferable to reduce the coating amount of the conductive polymer contained in the solid electrolyte layer 21 as much as possible.

The step of forming the cathode layer 20 preferably further includes a step of forming the conductor layer 22 on the surface of the solid electrolyte layer 21.

The step of forming the conductor layer 22 includes, for example, a step of forming the first conductor layer 22A on the surface of the solid electrolyte layer 21 and a step of forming the second conductor layer 22B on the surface of the first conductor layer 22A.

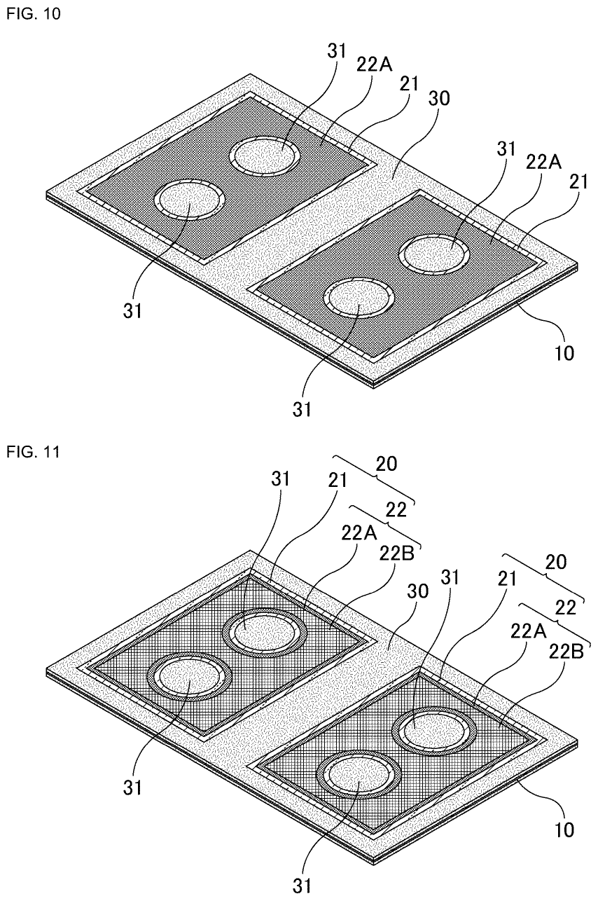

FIG. 10 is a perspective view schematically showing an example of a step of forming the first conductor layer.

As shown in FIG. 10, the first conductor layer 22A is formed on the surface of the solid electrolyte layer 21. The first conductor layer 22A is, for example, a conductive resin layer containing a conductive filler.

FIG. 11 is a perspective view schematically showing an example of a step of forming the second conductor layer.

As shown in FIG. 11, the second conductor layer 22B is formed on the surface of the first conductor layer 22A. As a result, the conductor layer 22 is formed. The second conductor layer 22B is, for example, a conductive resin layer containing a metal filler. As described above, the step of forming the conductor layer 22 may include a step of forming a conductive resin layer containing a metal filler.

For example, the conductor layer 22 includes a carbon layer as the first conductor layer 22A and a copper layer as the second conductor layer 22B.

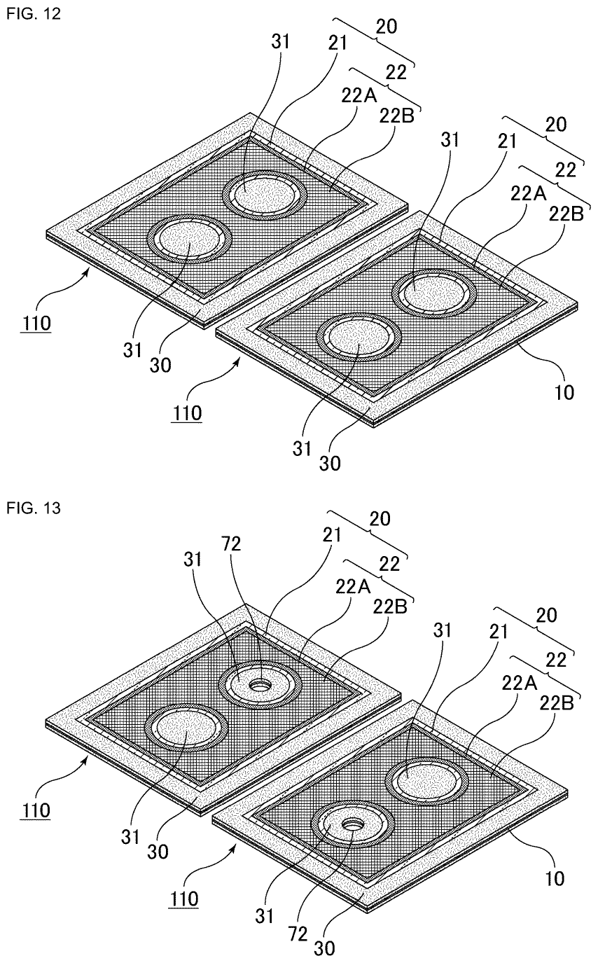

FIG. 12 is a perspective view schematically showing an example of a step of dividing the anode plate on which the cathode layer is formed.

As shown in FIG. 12, the anode plate 10 on which the cathode layer 20 is formed is cut to divide the element region, thereby isolating the anode plate 10 on which the cathode layer is formed into the plurality of solid electrolytic capacitors 110.

Examples of a method of dividing the anode plate 10 on which the cathode layer 20 is formed include laser processing and dicing processing.

As shown in FIG. 12, it is preferable that the anode plate 10 is divided between at least one pair of solid electrolytic capacitors 110 adjacent to each other among the plurality of solid electrolytic capacitors 110. That is, it is preferable that the anode plate 10 is divided by a slit extending through the anode plate 10 in the thickness direction between at least one pair of solid electrolytic capacitors 110 adjacent to each other.

In a case of forming the first insulating layer 31, the through-hole conductors 61 and 62 that penetrate the first insulating layer 31 in the thickness direction may be formed. For example, the through-hole conductor 61 may be formed inside the first through-hole 71, and the through-hole conductor 62 may be formed inside the second through-hole 72.

FIG. 13 is a perspective view schematically showing an example of a step of forming the second through-hole.

As shown in FIG. 13, the second through-hole 72 extending through the first insulating layer 31 in the thickness direction is formed as necessary.

Examples of the method of forming the second through-hole 72 include laser processing and drilling.

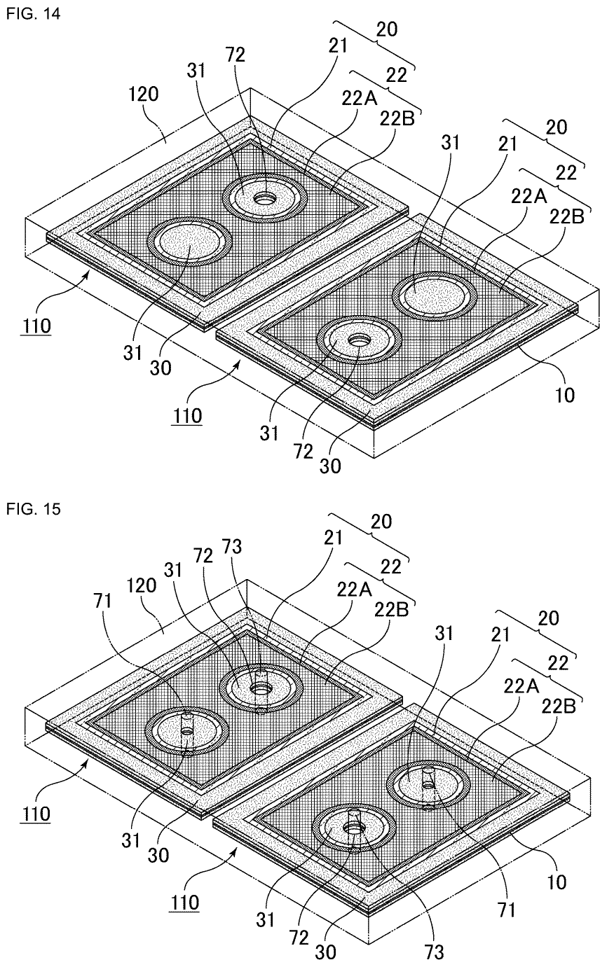

FIG. 14 is a perspective view schematically showing an example of a step of forming the sealing layer.

As shown in FIG. 14, for example, the sealing layer 120 is formed to cover the plurality of solid electrolytic capacitors 110 by providing the insulating material by press working or the like. The sealing layer 120 is formed to cover the cathode layer 20, the first insulating layer 30, and the first insulating layer 31. It is preferable that the sealing layer 120 is formed to cover the entire outer peripheral portion of the solid electrolytic capacitor 110, that is, to cover the upper, lower, left, and right sides of the solid electrolytic capacitor 110.

By forming the sealing layer 120, the space between the solid electrolytic capacitors 110 adjacent to each other may be filled with the sealing layer 120. The sealing layer 120 reliably divides the anode plates 10 from each other.

In addition, in a case where the second through-hole 72 is formed, the second through-hole 72 may be filled with the sealing layer 120.

FIG. 15 is a perspective view schematically showing an example of a step of forming the first through-hole.

As shown in FIG. 15, the first through-hole 71 extending through the first insulating layer 31 in the thickness direction is formed as necessary. The hole diameter of the first through-hole 71 is smaller than the hole diameter of the second through-hole 72.

Examples of the method of forming the first through-hole 71 include laser processing and drilling.

As shown in FIG. 15, the third through-hole 73 having a hole diameter smaller than the hole diameter of the second through-hole 72 may be further formed. The hole diameter of the third through-hole 73 may be the same as the hole diameter of the first through-hole 71, may be larger than the hole diameter of the first through-hole 71, or may be smaller than the hole diameter of the first through-hole 71.

Examples of the method of forming the third through-hole 73 include laser processing and drilling.

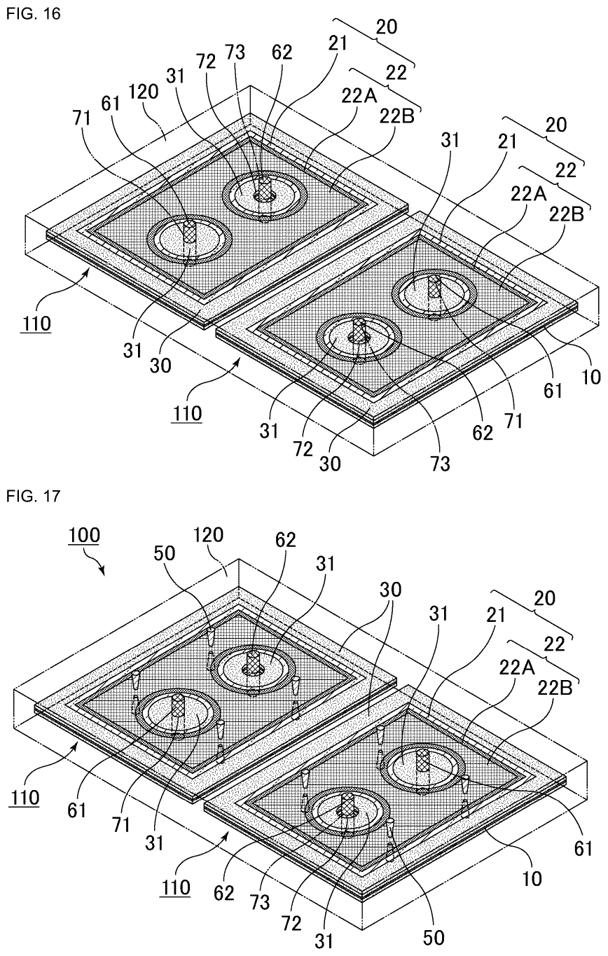

FIG. 16 is a perspective view schematically showing an example of a step of forming the through-hole conductor.

As shown in FIG. 16, the through-hole conductor 61 is formed inside the first through-hole 71, and the through-hole conductor 62 is formed inside the second through-hole 72.

The through-hole conductor 61 is formed to penetrate the solid electrolytic capacitor 110 and the sealing layer 120 in the thickness direction. It is preferable that the through-hole conductor 61 is electrically connected to the end surface of the anode plate 10 of the solid electrolytic capacitor 110 by the inner wall of the first through-hole 71 (that is, the side wall of the through-hole conductor 61). In the example shown in FIG. 16, the through-hole conductor 61 is formed to fill the first through-hole 71, but the through-hole conductor 61 may be formed only on at least the inner wall surface of the first through-hole 71.

The through-hole conductor 62 is formed to penetrate the solid electrolytic capacitor 110 and the sealing layer 120 in the thickness direction. It is preferable that the through-hole conductor 62 is electrically insulated from the anode plate 10 of the solid electrolytic capacitor 110 by the inner wall of the second through-hole 72 (that is, the side wall of the through-hole conductor 62). In the example shown in FIG. 16, the through-hole conductor 62 is formed to fill the third through-hole 73, but the through-hole conductor 62 may be formed only on at least the inner wall surface of the third through-hole 73.

As shown in FIG. 16, a space between the through-hole conductor 62 and the anode plate 10 may be filled with the sealing layer 120. The through-hole conductor 62 is reliably insulated from the anode plate 10 by the sealing layer 120 on the inner wall of the second through-hole 72.

FIG. 17 is a perspective view schematically showing an example of a step of forming the via conductor.

As shown in FIG. 17, the via conductor 50 may be formed in the sealing layer 120.

Thereafter, the first outer electrode 41 and the second outer electrode 42 (not shown) can be formed to manufacture the capacitor array 100 shown in FIG. 1.

As described above, in a case of manufacturing the capacitor array 100, examples of the method of dividing the anode plate 10 on which the cathode layer 20 is formed include laser processing and dicing processing. Among these, by using the laser processing, the element region can be formed in a free shape. Therefore, it is possible to dispose two or more types of solid electrolytic capacitors 110 having different areas of the element region in one capacitor array 100, to dispose the slits not to be applied to the entire capacitor array 100, and to dispose the solid electrolytic capacitor 110 having a planar shape of the cathode layer 20 which is not rectangular.

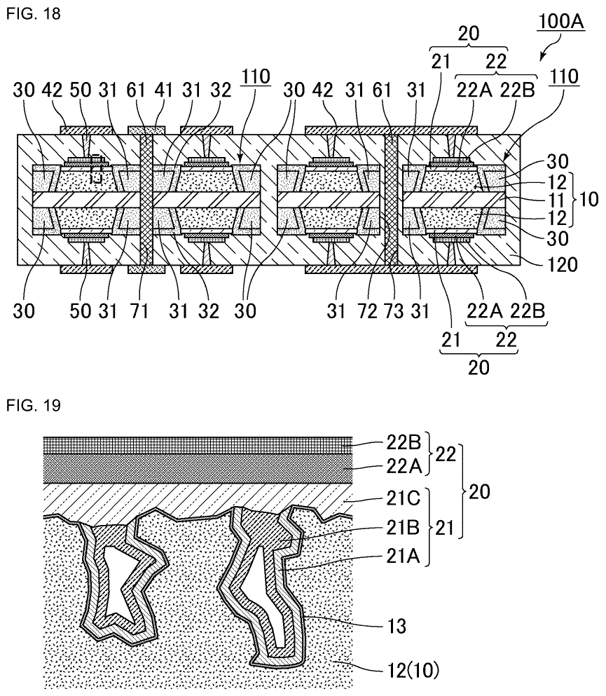

FIG. 18 is a cross-sectional view schematically showing another example of the capacitor array according to the present disclosure. FIG. 19 is an enlarged cross-sectional view of a part of the capacitor array shown in FIG. 18, which is surrounded by a broken line.

A capacitor array 100A shown in FIG. 18 further includes a second insulating layer 32 that is provided inside the pores of the porous layer 12 to cover a part of the solid electrolyte layer 21. The capacitor array 100A shown in FIG. 18 has the same configuration as the capacitor array 100 shown in FIG. 1, except for this point.

It is preferable that the second insulating layer 32 is provided to cover a part of the solid electrolyte layer 21 positioned in the vicinity of the first insulating layer 30 or 31. That is, it is preferable that the second insulating layer 32 is provided to cover the end of the solid electrolyte layer 21. In a case where both the first insulating layers 30 and 31 are provided, the second insulating layer 32 may be provided to cover both the part of the solid electrolyte layer 21 positioned in the vicinity of the first insulating layer 30 and the part of the solid electrolyte layer 21 positioned in the vicinity of the first insulating layer 31, or the second insulating layer 32 may be provided to cover any one of the parts.

The second insulating layer 32 may be provided to extend from the solid electrolyte layer 21 to cover the entire first insulating layer 30 or a part thereof. Similarly, the second insulating layer 32 may be provided to extend from the solid electrolyte layer 21 to cover the entire first insulating layer 31 or a part thereof.

In the periphery of the first insulating layer 30, since the wettability between the solid electrolyte layer 21 and the first insulating layer 30 is poor, the formation rate of the solid electrolyte layer 21 is likely to be reduced. The same applies to the periphery of the first insulating layer 31. A state where the conductive polymer is present but the solid electrolyte layer 21 is not formed is a state that is not preferable in terms of a mechanism such as expansion and capacitance variation due to intrusion of moisture. Therefore, by forming the second insulating layer 32 inside the pores of the porous layer 12 to cover a part of the solid electrolyte layer 21, the physical expansion can be suppressed.

In particular, in a case where a plurality of the solid electrolytic capacitors 110 are present inside the sealing layer 120 as in the capacitor array 100A, the proportion of the surface area of the first insulating layers 30 and 31 is increased, and thus the influence of the capacitance fluctuation due to the decrease in the formation rate of the solid electrolyte layer 21 is remarkable. Therefore, a method of forming the second insulating layer 32 is an effective method.

On the other hand, in a case where the second insulating layer 32 is provided in a wide range, the conductive path itself is impaired, which leads to an increase in resistance. Therefore, it is preferable that the second insulating layer 32 is provided in a range of 1 μm to 100 μm from the end of the first insulating layer 30 or 31 toward the solid electrolyte layer 21.

The second insulating layer 32 contains an insulating material.

The second insulating layer 32 is preferably made of a resin. Examples of the resin constituting the second insulating layer 32 include insulating resins such as a polyphenylsulfone resin, a polyethersulfone resin, a cyanate ester resin, a fluororesin (tetrafluoroethylene, a tetrafluoroethylene-perfluoroalkyl vinyl ether copolymer, and the like), a polyimide resin, a polyamideimide resin, and an epoxy resin, and derivatives or precursors thereof. The second insulating layer 32 may be formed of the same resin as the first insulating layer 30 or 31, or may be formed of a different resin.

Since there is a concern that the inorganic filler contained in the second insulating layer 32 may have an adverse effect on the effective portion of the solid electrolytic capacitor 110, it is preferable that the second insulating layer 32 is made of a resin alone.

The second insulating layer 32 can be formed, for example, by applying a mask material such as a composition containing an insulating resin by a method such as sponge transfer, screen printing, dispenser coating, or ink jet printing to cover a part of the solid electrolyte layer 21.

It is preferable that the inside of the pores of the porous layer 12 is filled with the second insulating layer 32. The second insulating layer 32 may be provided on the surface of the anode plate 10.

The capacitor array according to the present disclosure can be suitably used as a configuration material of a composite electronic component. Such a composite electronic component includes, for example, the capacitor array according to the present disclosure, the outer electrode that is provided on the outer side portion of the capacitor array and is connected to each of the anode plate and the cathode layer of the solid electrolytic capacitor, and an electronic component connected to the outer electrode.

In the composite electronic component, the electronic component connected to the outer electrode may be a passive element or an active element. Both the passive element and the active element may be connected to the outer electrode, or one of the passive element and the active element may be connected to the outer electrode. In addition, a complex of the passive element and the active element may be connected to the outer electrode.

Examples of the passive element include an inductor or the like. Examples of the active element include a memory, a graphical processing unit (GPU), a central processing unit (CPU), a micro processing unit (MPU), and a power management IC (PMIC).

The capacitor array according to the present disclosure has a sheet-like shape as a whole. Therefore, in the composite electronic component, the capacitor array can be treated as the mounting substrate, and the electronic component can be mounted on the capacitor array. Further, by making the shape of the electronic component mounted on the capacitor array into a sheet shape, it is also possible to connect the capacitor array and the electronic component in the thickness direction with the through-hole conductor penetrating each electronic component in the thickness direction interposed therebetween. As a result, the active element and the passive element can be configured as a single module.

For example, the capacitor array according to the present disclosure can be electrically connected between a voltage regulator including a semiconductor active element and a load to which a converted DC voltage is supplied to form a switching regulator.

In the composite electronic component, a circuit layer may be formed on either surface of the capacitor matrix sheet on which a plurality of capacitor arrays of the present disclosure are further laid out, and then the capacitor arrays may be connected to the passive element or the active element.

In addition, the capacitor array according to the present disclosure may be disposed in a cavity portion provided in a substrate in advance, and then the cavity portion may be embedded with a resin, and a circuit layer may be formed on the resin. Another electronic component (passive element or active element) may be mounted in another cavity portion of the same substrate.

Alternatively, the capacitor array according to the present disclosure may be mounted on a smooth carrier such as a wafer or glass, an outer layer portion may be formed of a resin, and then a circuit layer may be formed, and the capacitor array may be connected to the passive element or the active element.

The following contents are disclosed in this specification.

<1> A solid electrolytic capacitor including: an anode plate including a core portion, a porous layer having pores on at least one main surface of the core portion, and a dielectric layer on a surface of the porous layer and extending into the pores of the porous layer; and a cathode layer that includes a solid electrolyte layer on a surface of the dielectric layer, the solid electrolyte layer including a conductive polymer layer inside the pores of the porous layer, the conductive polymer layer comprising a mixture of a conductive polymer and an insulating material, wherein the insulating material is a material which contains an OH group, a COOH group, a CO group, or an NH₂ group in a molecule, has hygroscopicity, and does not have a function as a dopant for the conductive polymer.

<2> The solid electrolytic capacitor according to <1>, further including: a first insulating layer on the surface of the porous layer in a region where the cathode layer is not located.

<3> The solid electrolytic capacitor according to <2>, further including: a second insulating layer inside the pores of the porous layer and covering a part of the solid electrolyte layer.

<4> The solid electrolytic capacitor according to <3>, in which the second insulating layer is provided in a range of 1 μm to 100 μm from an end of the first insulating layer toward the solid electrolyte layer.

<5> The solid electrolytic capacitor according to any one of <2> to <4>, in which the first insulating layer surrounds the cathode layer when viewed in a thickness direction of the solid electrolytic capacitor.

<6> The solid electrolytic capacitor according to any one of <2> to <4>, in which the first insulating layer is on an inner side portion of the cathode layer when viewed in a thickness direction of the solid electrolytic capacitor.

<7> The solid electrolytic capacitor according to any one of <1> to <6>, further including: a sealing layer covering the solid electrolytic capacitor; a first outer electrode and a second outer electrode on an outer side portion of the sealing layer; a via conductor inside the sealing layer; and a through-hole conductor penetrating the sealing layer in a thickness direction of the solid electrolytic capacitor, wherein the through-hole conductor is electrically connected to an end surface of the anode plate of the solid electrolytic capacitor on a side wall of the through-hole conductor, the first outer electrode is electrically connected to the anode plate of the solid electrolytic capacitor with the through-hole conductor interposed therebetween, and the second outer electrode is electrically connected to the cathode layer of the solid electrolytic capacitor with the via conductor interposed therebetween.

<8> A capacitor array including: two or more of the solid electrolytic capacitors according to any one of <1> to <6>; a sealing layer covering the two or more of the solid electrolytic capacitors; a first outer electrode and a second outer electrode on an outer side portion of the sealing layer; a via conductor inside the sealing layer; and a through-hole conductor penetrating the sealing layer in a thickness direction of the solid electrolytic capacitor, wherein the through-hole conductor is electrically connected to an end surface of the anode plate of one of the two or more of the solid electrolytic capacitors on a side wall of the through-hole conductor, the first outer electrode is electrically connected to the anode plate of the one of the two or more of the solid electrolytic capacitors with the through-hole conductor interposed therebetween, and the second outer electrode is electrically connected to the cathode layer of the one of the two or more of the solid electrolytic capacitors with the via conductor interposed therebetween.

<9> The capacitor array according to <8>, in which a space between adjacent solid electrolytic capacitors of the two or more of the solid electrolytic capacitors is filled with a same material as the sealing layer.

### EXAMPLES

Hereinafter, examples of the solid electrolytic capacitor and the capacitor array according to the present disclosure will be shown in more detail. The present disclosure is not limited to the above examples.

### Example 1

In Example 1, the capacitor array 100 shown in FIG. 1 was produced.

An aluminum sheet having a porous layer and an oxide film on both surfaces was prepared, and a mask layer (first insulating layer) surrounding an effective portion (element region) which is a capacitance portion of the solid electrolytic capacitor and an insulating column layer (first insulating layer) for forming a through-hole conductor in the effective portion were formed by coating with an insulating resin. A process of coating the formed effective portion with a conductive polymer ink obtained by dissolving a conductive polymer, which was represented by poly(3,4-ethylenedioxythiophene) as the first conductive polymer and was soluble in a solvent, and then drying the conductive polymer ink was performed a plurality of times to form a first conductive polymer layer on the surface of the dielectric layer.

Next, a process of simultaneously performing coating with a dispersion liquid in which the second conductive polymer different from the first conductive polymer was dispersed and a solution in which an insulating material having hygroscopicity and not having a function as a dopant for the conductive polymer contained in the solid electrolyte layer was dissolved, and then drying the dispersion liquid and solution was performed a plurality of times to form a second conductive polymer layer in which the insulating material was mixed in a continuous conductive region. As the second conductive polymer, a conductive polymer represented by poly(3,4-ethylenedioxythiophene) was used, which had a larger particle size than the first conductive polymer and was insoluble in a solvent but had high heat resistance. As an insulating material, a phenol-based material having hygroscopicity was used.

Subsequently, a third conductive polymer layer was formed by coating the effective portion with a third conductive polymer, thereby forming a solid electrolyte layer. Thereafter, as the conductor layer, the first conductor layer and the second conductor layer were each formed by coating. A carbon layer was formed as the first conductor layer, and a copper layer was formed as the second conductor layer. In this manner, a solid electrolytic capacitor sheet was obtained.

A resin sheet was attached to the upper and lower surfaces of the obtained solid electrolytic capacitor sheet, and the resin sheet was pressure-bonded to the solid electrolytic capacitor sheet at a temperature equal to or higher than the glass transition point, thereby obtaining a capacitor array sheet having a smooth surface.

The capacitor array sheet was cut such that each solid electrolytic capacitor was independent, and then the formed grooves (slits) were filled with the resin sheet again by being pressure-bonded at a temperature equal to or higher than the glass transition point.

A sealing layer formed of a resin sheet was provided with a hole formed toward the second conductor layer, and the inside of the formed hole was filled with a conductive material to form a via conductor serving as a cathode lead electrode.

In addition, a through-hole was formed in the insulating column layer (first insulating layer), and a plating treatment was performed on the formed through-hole and the exposed wall surface of the aluminum sheet to form a through-hole conductor serving as a lead electrode of the anode.

The obtained capacitor array sheet was cut to be individualized to obtain a solid electrolytic capacitor of Example 1.

In the solid electrolytic capacitor of Example 1, the fluctuation of the capacitance due to the moisture absorption and swelling can be suppressed by the swelling of the insulating material.

### Example 2

In Example 2, the capacitor array 100A shown in FIG. 18 was produced.

An aluminum sheet having a porous layer and an oxide film on both surfaces was prepared, and a mask layer (first insulating layer) surrounding an effective portion (element region) which is a capacitance portion of the solid electrolytic capacitor and an insulating column layer (first insulating layer) for forming a through-hole conductor in the effective portion were formed by coating with an insulating resin. A process of coating the formed effective portion with a conductive polymer ink obtained by dissolving a conductive polymer, which was represented by poly(3,4-ethylenedioxythiophene) as the first conductive polymer and was soluble in a solvent, and then drying the conductive polymer ink was performed a plurality of times to form a first conductive polymer layer on the surface of the dielectric layer.

Next, a process of simultaneously performing coating with a dispersion liquid in which the second conductive polymer different from the first conductive polymer was dispersed and a solution in which an insulating material having hygroscopicity and not having a function as a dopant for the conductive polymer contained in the solid electrolyte layer was dissolved, and then drying the dispersion liquid and solution was performed a plurality of times to form a second conductive polymer layer in which the insulating material was mixed in a continuous conductive region. As the second conductive polymer, a conductive polymer represented by poly(3,4-ethylenedioxythiophene) was used, which had a larger particle size than the first conductive polymer and was insoluble in a solvent but had high heat resistance. As an insulating material, a phenol-based material having hygroscopicity was used.

Subsequently, a third conductive polymer layer was formed by coating the effective portion with a third conductive polymer, thereby forming a solid electrolyte layer. In a case of forming the solid electrolyte layer, in order to suppress a risk of short-circuiting due to direct contact between the aluminum sheet and a conductor layer to be described later, a liquid having a higher viscosity than the liquid used for forming the first conductive polymer layer and the second conductive polymer layer was used for coating such that the aluminum sheet was not exposed on the surface.

After forming the solid electrolyte layer, the mask layer (first insulating layer) and the insulating column layer (first insulating layer) were coated with the insulating resin by expanding the coating area by 50 μm toward the effective portion side, thereby forming a second insulating layer.

Thereafter, as the conductor layer, the first conductor layer and the second conductor layer were each formed by coating. A carbon layer was formed as the first conductor layer, and a copper layer was formed as the second conductor layer. In this manner, a solid electrolytic capacitor sheet was obtained.

A resin sheet was attached to the upper and lower surfaces of the obtained solid electrolytic capacitor sheet, and the resin sheet was pressure-bonded to the solid electrolytic capacitor sheet at a temperature equal to or higher than the glass transition point, thereby obtaining a capacitor array sheet having a smooth surface.

The capacitor array sheet was cut such that each solid electrolytic capacitor was independent, and then the formed grooves (slits) were filled with the resin sheet again by being pressure-bonded at a temperature equal to or higher than the glass transition point.

A sealing layer formed of a resin sheet was provided with a hole formed toward the second conductor layer, and the inside of the formed hole was filled with a conductive material to form a via conductor serving as a cathode lead electrode.

In addition, a through-hole was formed in the insulating column layer (first insulating layer), and a plating treatment was performed on the formed through-hole and the exposed wall surface of the aluminum sheet to form a through-hole conductor serving as a lead electrode of the anode.

The obtained capacitor array sheet was cut to be individualized to obtain a solid electrolytic capacitor of Example 2.

In the solid electrolytic capacitor of Example 2, in addition to Example 1, a state where the mask layer cannot be physically swollen can be formed by embedding the vicinity of the mask layer with an insulating resin. However, since the conductivity is reduced in a case where the entire surface is embedded, it is preferable to selectively embed only the vicinity of the mask layer.

### Comparative Example 1

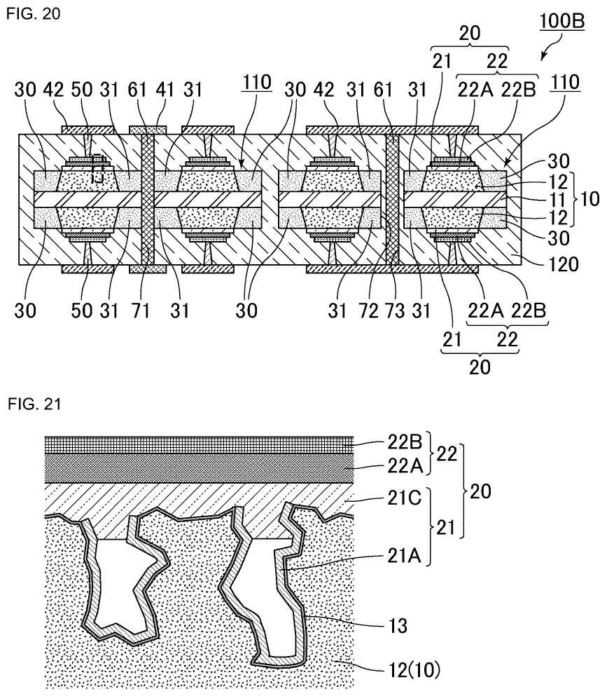

In Comparative Example 1, a capacitor array 100B shown in FIG. 20 was produced.

FIG. 20 is a cross-sectional view schematically showing an example of the capacitor array of Comparative Example 1. FIG. 21 is an enlarged cross-sectional view of a part of the capacitor array shown in FIG. 20, which is surrounded by a broken line.

An aluminum sheet having a porous layer and an oxide film on both surfaces was prepared, and a mask layer (first insulating layer) surrounding an effective portion (element region) which is a capacitance portion of the solid electrolytic capacitor and an insulating column layer (first insulating layer) for forming a through-hole conductor in the effective portion were formed by coating with an insulating resin. A process of coating the formed effective portion with a dispersion liquid in which the second conductive polymer was dispersed and then drying the dispersion liquid was performed a plurality of times to form a first conductive polymer layer on the surface of the dielectric layer.

Subsequently, a third conductive polymer layer was formed on the effective portion to form a solid electrolyte layer. Thereafter, as the conductor layer, the first conductor layer and the second conductor layer were each formed by coating. A carbon layer was formed as the first conductor layer, and a copper layer was formed as the second conductor layer. In this manner, a solid electrolytic capacitor sheet was obtained.

A resin sheet was attached to the upper and lower surfaces of the obtained solid electrolytic capacitor sheet, and the resin sheet was pressure-bonded to the solid electrolytic capacitor sheet at a temperature equal to or higher than the glass transition point, thereby obtaining a capacitor array sheet having a smooth surface.

The capacitor array sheet was cut such that each solid electrolytic capacitor was independent, and then the formed grooves (slits) were filled with the resin sheet again by being pressure-bonded at a temperature equal to or higher than the glass transition point.

A sealing layer formed of a resin sheet was provided with a hole formed toward the second conductor layer, and the inside of the formed hole was filled with a conductive material to form a via conductor serving as a cathode lead electrode.

In addition, a through-hole was formed in the insulating column layer (first insulating layer), and a plating treatment was performed on the formed through-hole and the exposed wall surface of the aluminum sheet to form a through-hole conductor serving as a lead electrode of the anode.

The obtained capacitor array sheet was cut to be individualized to obtain a solid electrolytic capacitor of Comparative Example 1.

For the solid electrolytic capacitors of Example 2 and Comparative Example 1, a capacitance variation rate (ΔCap) in a case where only the humidity was changed and the capacitor was left to stand for 48 hours was measured with reference to a measured value after the capacitor was left to stand for 48 hours in the atmosphere of the temperature of 22° C. and the humidity of 60%.

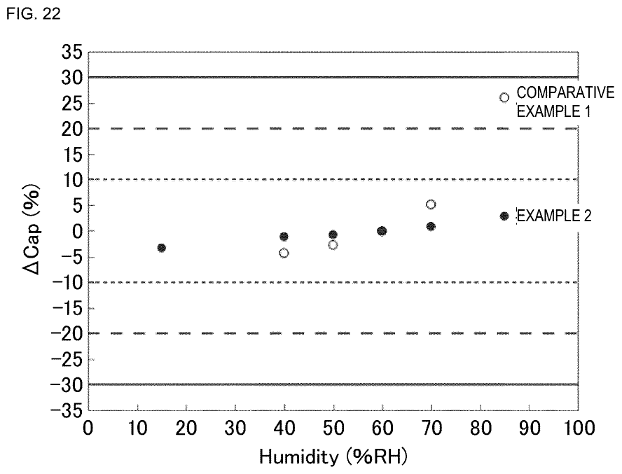

FIG. 22 is a graph showing a relationship between a humidity and a capacitance variation rate in the solid electrolytic capacitor of Example 2 and Comparative Example 1.

From FIG. 22, it can be seen that, in the solid electrolytic capacitor of Example 2, the capacitance variation rate in a high humidity environment is suppressed as compared with the solid electrolytic capacitor of Comparative Example 1.

### REFERENCE SIGNS LIST

10 ANODE PLATE
11 CORE PORTION
12 POROUS LAYER
13 DIELECTRIC LAYER
20 CATHODE LAYER
21 SOLID ELECTROLYTE LAYER
21A FIRST CONDUCTIVE POLYMER LAYER
21B SECOND CONDUCTIVE POLYMER LAYER
21C THIRD CONDUCTIVE POLYMER LAYER
22 CONDUCTOR LAYER
22A FIRST CONDUCTOR LAYER
22B SECOND CONDUCTOR LAYER
30, 31 FIRST INSULATING LAYER
32 SECOND INSULATING LAYER
41 FIRST OUTER ELECTRODE
42 SECOND OUTER ELECTRODE
50 VIA CONDUCTOR
61, 62 THROUGH-HOLE CONDUCTOR
71 FIRST THROUGH-HOLE
72 SECOND THROUGH-HOLE
73 THIRD THROUGH-HOLE
100, 100A, 100B CAPACITOR ARRAY
110 SOLID ELECTROLYTIC CAPACITOR
120 SEALING LAYER

1. A solid electrolytic capacitor comprising:
an anode plate including a core portion, a porous layer having pores on at least one main surface of the core portion, and a dielectric layer on a surface of the porous layer and extending into the pores of the porous layer; and
a cathode layer that includes a solid electrolyte layer on a surface of the dielectric layer, the solid electrolyte layer including a conductive polymer layer inside the pores of the porous layer, the conductive polymer layer comprising a mixture of a conductive polymer and an insulating material, wherein
the insulating material is a material which contains an OH group, a COOH group, a CO group, or an NH₂ group in a molecule, has hygroscopicity, and does not have a function as a dopant for the conductive polymer.

2. The solid electrolytic capacitor according to claim 1, wherein the conductive polymer layer is a first conductive polymer layer, the conductive polymer is a first conductive polymer, and the solid electrolyte layer further includes a second conductive polymer layer on at least a part of a surface of the first conductive polymer layer and inside the pores of the porous layer, the second conductive polymer layer comprising a mixture of a second conductive polymer and the insulating material.

3. The solid electrolytic capacitor according to claim 2, wherein the second conductive polymer is different from the first conductive polymer.

4. The solid electrolytic capacitor according to claim 2, wherein the second conductive polymer has a larger particle size than the first conductive polymer.

5. The solid electrolytic capacitor according to claim 2, wherein the solid electrolyte layer further includes a third conductive polymer layer on at least a part of a surface of the second conductive polymer layer.

6. The solid electrolytic capacitor according to claim 1, further comprising:
a first insulating layer on the surface of the porous layer in a region where the cathode layer is not located.

7. The solid electrolytic capacitor according to claim 6, further comprising:
a second insulating layer inside the pores of the porous layer and covering a part of the solid electrolyte layer.

8. The solid electrolytic capacitor according to claim 7, wherein the second insulating layer is provided in a range of 1 μm to 100 μm from an end of the first insulating layer toward the solid electrolyte layer.

9. The solid electrolytic capacitor according to claim 6, wherein the first insulating layer surrounds the cathode layer when viewed in a thickness direction of the solid electrolytic capacitor.

10. The solid electrolytic capacitor according to claim 6, wherein the first insulating layer is on an inner side portion of the cathode layer when viewed in a thickness direction of the solid electrolytic capacitor.

11. The solid electrolytic capacitor according to claim 1, further comprising:
a sealing layer covering the solid electrolytic capacitor;
a first outer electrode and a second outer electrode on an outer side portion of the sealing layer;
a via conductor inside the sealing layer; and
a through-hole conductor penetrating the sealing layer in a thickness direction of the solid electrolytic capacitor, wherein
the through-hole conductor is electrically connected to an end surface of the anode plate of the solid electrolytic capacitor on a side wall of the through-hole conductor,
the first outer electrode is electrically connected to the anode plate of the solid electrolytic capacitor with the through-hole conductor interposed therebetween, and
the second outer electrode is electrically connected to the cathode layer of the solid electrolytic capacitor with the via conductor interposed therebetween.

12. The solid electrolytic capacitor according to claim 11, wherein the conductive polymer layer is a first conductive polymer layer, the conductive polymer is a first conductive polymer, and the solid electrolyte layer further includes a second conductive polymer layer on at least a part of a surface of the first conductive polymer layer and inside the pores of the porous layer, the second conductive polymer layer comprising a mixture of a second conductive polymer and the insulating material.

13. The solid electrolytic capacitor according to claim 12, wherein the solid electrolyte layer further includes a third conductive polymer layer on at least a part of a surface of the second conductive polymer layer.

14. The solid electrolytic capacitor according to claim 11, further comprising:
a first insulating layer on the surface of the porous layer in a region where the cathode layer is not located.

15. The solid electrolytic capacitor according to claim 14, further comprising:
a second insulating layer inside the pores of the porous layer and covering a part of the solid electrolyte layer.

16. The solid electrolytic capacitor according to claim 15, wherein the second insulating layer is provided in a range of 1 μm to 100 μm from an end of the first insulating layer toward the solid electrolyte layer.

17. The solid electrolytic capacitor according to claim 16, wherein the first insulating layer surrounds the cathode layer when viewed in a thickness direction of the solid electrolytic capacitor.

18. The solid electrolytic capacitor according to claim 16, wherein the first insulating layer is on an inner side portion of the cathode layer when viewed in a thickness direction of the solid electrolytic capacitor.

19. A capacitor array comprising:
two or more of the solid electrolytic capacitors according to claim 1;
a sealing layer covering the two or more of the solid electrolytic capacitors;
a first outer electrode and a second outer electrode on an outer side portion of the sealing layer;
a via conductor inside the sealing layer; and
a through-hole conductor penetrating the sealing layer in a thickness direction of the solid electrolytic capacitor, wherein
the through-hole conductor is electrically connected to an end surface of the anode plate of one of the two or more of the solid electrolytic capacitors on a side wall of the through-hole conductor,
the first outer electrode is electrically connected to the anode plate of the one of the two or more of the solid electrolytic capacitors with the through-hole conductor interposed therebetween, and
the second outer electrode is electrically connected to the cathode layer of the one of the two or more of the solid electrolytic capacitors with the via conductor interposed therebetween.

20. The capacitor array according to claim 19, wherein a space between adjacent solid electrolytic capacitors of the two or more of the solid electrolytic capacitors is filled with a same material as the sealing layer.
